(19) United States
(12) Patent Application Publication
(10) Pub. No.: US 2010/0092351 A1
(43) Pub. Date: Apr. 15, 2010

(54) Molecular Sieve and Catalyst Incorporating the Sieve

(75) Inventors: John E. Bauer, LaGrange Park, IL (US); Jaime G. Moscoso, Mount Prospect, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Des Plaines, IL (US)

(21) Appl. No.: 12/639,088

(22) Filed: Dec. 16, 2009

Related U.S. Application Data
(62) Division of application No. 11/954,637, filed on Dec. 12, 2007.

(51) Int. Cl. B01J 8/00

(52) U.S. Cl. 422/187

(57) ABSTRACT

One exemplary embodiment can be a molecular sieve for a catalyst for isomerizing xylenes. Generally, the molecular sieve, including at least one of an MFI, MEL, FER, MOR, TON, MTW, EUO, and MTT zeolite, can include:
at least about 40%, by weight, silicon;
about 0.5-about 7.0%, by weight, gallium; and
about 0.1-about 2.0%, by weight, of another IUPAC Group 13 element wherein the silicon, gallium and the another IUPAC Group 13 element are calculated on an elemental basis.

### CROSS-REFERENCE TO RELATED APPLICATION

This application is a Division of copending application Ser. No. 11/954,637 filed Dec. 12, 2007, the contents of which are hereby incorporated by reference in its entirety.

### FIELD OF THE INVENTION

The field of this invention generally relates to a molecular sieve and/or catalyst for a C8 aromatic isomerization process or unit.

### BACKGROUND OF THE INVENTION

The xylenes, such as para-xylene, meta-xylene and ortho-xylene, can be important intermediates that find wide and varied application in chemical syntheses. Generally, para-xylene upon oxidation yields terephthalic acid that is used in the manufacture of synthetic textile fibers and resins. Meta-xylene can be used in the manufacture of plasticizers, azo dyes, and wood preservers. Generally, ortho-xylene is a feedstock for phthalic anhydride production.

Xylene isomers from catalytic reforming or other sources generally do not match demand proportions as chemical intermediates, and further comprise ethylbenzene, which can be difficult to separate or to convert. Typically, para-xylene is a major chemical intermediate with significant demand, but amounts to only 20-25% of a typical C8 aromatic stream. Adjustment of an isomer ratio to demand can be effected by combining xylene-isomer recovery, such as adsorption for para-xylene recovery, with isomerization to yield an additional quantity of the desired isomer. Typically, isomerization converts a non-equilibrium mixture of the xylene isomers that is lean in the desired xylene isomer to a mixture approaching equilibrium concentrations. It is also desirable to convert ethylbenzene to one or more xylenes while minimizing xylene loss. Moreover, other desired aromatic products, such as benzene, can be produced from such processes.

Various catalysts and processes have been developed to effect xylene isomerization. In one such system, isomerization can include separate reactors having different functions. Particularly, one reactor can perform xylene isomerization with low ethylbenzene conversion, while the other reactor may perform ethylbenzene conversion with low xylene isomerization. If the ethylbenzene reactor can selectively convert ethylbenzene into one of the xylene isomers, typically para-xylene, then above-equilibrium levels of the preferred isomer can be obtained. One way to reduce loss of cyclic hydrocarbons having eight carbon atoms (hereinafter may be abbreviated as “C8 ring loss” or “C8RL”) is to operate in a liquid phase. In absence of hydrogen, saturation and cracking reactions may be essentially eliminated. Because the liquid phase process is typically at a lower temperature than a gas-phase system, high active-material content is typically required. As a result, it is preferable that the activity of the catalyst be very high to reduce the quantity and cost of the catalyst, and the capital costs associated by large catalyst volumes.

Although such catalysts are known, particularly those catalysts having gallium, it would be desirable to provide a catalyst having greater xylene isomerization activity while minimizing C8RL. Activity of a gallium catalyst can be increased by adding one or more other metals and/or modifiers. However, adding other materials to increase isomerization activity can result in undesired side reactions during the isomerization of xylenes and/or ethylbenzene, potentially resulting in C8RL.

### BRIEF SUMMARY OF THE INVENTION

One exemplary embodiment can be a molecular sieve for a catalyst for isomerizing xylenes. Generally, the molecular sieve, including at least one of an MFI, MEL, FER, MOR, TON, MTW, EUO, and MTT zeolite, can include:

at least about 40%, by weight, silicon;

about 0.5-about 7.0%, by weight, gallium; and

about 0.1-about 2.0%, by weight, of another IUPAC Group 13 element wherein the silicon, gallium and the another IUPAC Group 13 element are calculated on an elemental basis.

Another exemplary embodiment can be a catalyst for isomerizing xylenes including a molecular sieve and a binder. The molecular sieve, including at least one of an MFI, MEL, FER, MOR, TON, MTW, EUO, and MTT zeolite, can include:

at least about 40%, by weight, silicon;

about 0.5-about 7.0%, by weight, gallium; and

about 0.1-about 2.0%, by weight, of another IUPAC Group 13 element wherein the silicon, gallium and the another IUPAC Group 13 element are calculated on an elemental basis.

A further exemplary embodiment can be an aromatic production facility. The aromatic production facility can include a xylene isomer separation unit and a C8 aromatic isomerization unit receiving a stream depleted in at least one xylene isomer from the xylene isomer separation unit. Generally, the C8 aromatic isomerization unit includes at least one zone at least for isomerizing at least one xylene that can include a catalyst. The catalyst may include a molecular sieve and a binder. Generally, the molecular sieve, including at least one of an MFI, MEL, FER, MOR, TON, MTW, EUO, and MTT zeolite, has:

at least about 40%, by weight, silicon;

about 0.5-about 7.0%, by weight, gallium; and

about 0.1-about 2.0%, by weight, of another IUPAC Group 13 element where the silicon, gallium and the another IUPAC Group 13 element are calculated on an elemental basis.

Therefore, the catalyst can provide a favorable balance of activity, selectivity, and stability. Particularly, the catalyst can provide increased isomerization of xylenes while minimizing C8RL. As an example, a catalyst containing gallium can be useful for isomerizing C8 hydrocarbons. In this instance, adding a specified amount of aluminum to the gallium in the catalyst can not only increase isomerization activity, but with minimal impact on C8RL.

### DEFINITIONS

As used herein, the term “zone” can refer to an area including one or more equipment items and/or one or more sub-zones. Equipment items can include one or more reactors or reactor vessels, heaters, separators, exchangers, pipes, pumps, compressors, and controllers. Additionally, an equipment item, such as a reactor or vessel, can further include one or more zones or sub-zones.

As used herein, the term “stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals. The stream can also include aromatic and non-aromatic hydrocarbons. Moreover, the hydrocarbon molecules may be abbreviated C1, C2, C3 . . . Cn where “n” represents the number of carbon atoms in the hydrocarbon molecule.

As used herein, the term “aromatic” can mean a group containing one or more rings of unsaturated cyclic carbon radicals where one or more of the carbon radicals can be replaced by one or more non-carbon radicals. An exemplary aromatic compound is benzene having a C6 ring containing three double bonds. Other exemplary aromatic compounds can include para-xylene, ortho-xylene, meta-xylene and ethylbenzene. Moreover, characterizing a stream or zone as “aromatic” can imply one or more different aromatic compounds.

As used herein, the term “support” generally means a molecular sieve that has been combined with a binder before the addition of one or more additional catalytically active components, such as a metal, or the application of a subsequent process such as reducing, sulfiding, calcining, or drying. However, in some instances, a support may have catalytic properties and can be used as a “catalyst”.

As used herein, the term “non-equilibrium” generally means at least one C8 aromatic isomer can be present in a concentration that differs substantially from the equilibrium concentration at a different isomerization condition.

As used herein, the term “substantial absence of hydrogen” generally means that no free hydrogen is added to a feed mixture and that any dissolved hydrogen from prior processing is substantially less than about 0.05 moles/mole of feed, frequently less than about 0.01 moles/mole, and possibly not detectable by usual analytical methods.

### DETAILED DESCRIPTION OF THE INVENTION

Generally, a first isomerization catalyst includes a molecular sieve, such as an aluminosilicate zeolite, having a Si:Al₂ ratio greater than about 10, preferably greater than about 20, and a pore diameter of about 5-about 8 angstroms (Å). Specific examples of suitable zeolites are MFI, MEL, EUO, FER, MTT, MTW, TON, and MOR zeolites. Such a first isomerization catalyst can be used in a first isomerization zone of a C8 isomerization unit having two zones, as discussed hereinafter.

Preferably, the aluminosilicate zeolite has a greater number of low acid strength activity sites than high acid strength activity sites. Such an aluminosilicate zeolite can contain gallium to provide low acid strength activity sites and aluminum to provide high acid strength activity sites. One exemplary MFI-type zeolite is a gallium-aluminum-MFI, with gallium and aluminum as components of the crystal structure. Although not wanting to be bound by theory, it is believed that adding small amounts of aluminum can increase isomerization activity while minimizing C8 ring loss.

Generally, the preparation of zeolites by crystallizing a mixture including aluminum and gallium sources, a silica source, and optionally an alkali metal source is known. Conversion of an alkali-metal-form zeolite to the hydrogen form may be performed by treatment with an aqueous solution of a mineral acid. Alternatively, hydrogen ions may be incorporated into the pentasil zeolite by ion exchange with ammonium salts such as ammonium hydroxide or ammonium nitrate followed by calcination. An aluminosilicate zeolite can contain at least about 40%, and preferably about 40-about 46%, by weight, silicon, based on the molecular sieve. In addition, the aluminosilicate zeolite may contain generally about 0.5-about 7.0%, desirably about 2.0-about 5.0%, and optimally about 2.5-about 3.5%, by weight, gallium, based on the molecular sieve. Furthermore, the aluminosilicate zeolite can contain generally about 0.1-about 2.0%, desirably about 0.1-about 1.0%, and optimally about 0.2-about 0.4%, by weight, of another IUPAC Group 13 element, such as aluminum, based on the molecular sieve. In other preferred embodiments, the zeolite can contain about 3.0-about 4.0%, by weight, gallium, and about 0.2-about 1.0%, preferably about 0.2-about 0.6%, by weight, of another IUPAC Group 13 element, such as aluminum. Desirably, the metals are present as oxides in the zeolite.

The porous microcrystalline material of the isomerization catalyst preferably is composited with a binder. Generally, the proportion of binder in the catalyst is no more than about 90%, preferably about 10-about 70%, and optimally about 50%, by weight. The remainder can be metal and other components discussed herein. Typically, the catalyst can contain about 30-about 90%, preferably about 50%, by weight, of the aluminosilicate zeolite.

Usually catalyst particles are homogeneous with no concentration gradients of the catalyst components. Alternatively, the catalyst particles may be layered, for example, with an outer layer of a bound zeolite bonded to a relatively inert core. Examples of layered catalysts can be found in U.S. Pat. No. 6,376,730 B1 and U.S. Pat. No. 4,283,583.

The binder should be a porous, adsorptive material having a surface area of about 25-about 500 m²/g that is relatively refractory to conditions utilized in a hydrocarbon conversion process. Typically, the binder can include (1) a refractory inorganic oxide such as an alumina, a titania, a zirconia, a chromia, a zinc oxide, a magnesia, a thoria, a boria, a silica-alumina, a silica-magnesia, a chromia-alumina, an alumina-boria, or a silica-zirconia; (2) a ceramic, a porcelain, or a bauxite; (3) a silica or silica gel, a silicon carbide, a synthetically prepared or naturally occurring clay or silicate, optionally acid treated, as an example, an attapulgite clay, a diatomaceous earth, a fuller's earth, a kaolin, or a kieselguhr; (4) a crystalline zeolitic aluminosilicate, either naturally occurring or synthetically prepared, such as FAU, MEL, MFI, MOR, MTW (IUPAC Commission on Zeolite Nomenclature), in hydrogen form or in a form that has been exchanged with metal cations, (5) a spinel, such as MgAl₂O₄, FeAl₂O₄, ZnAl₂O₄, CaAl₂O₄, or a compound having a formula MO—Al₂O₃ where M is a metal having a valence of 2; or (6) a combination of two or more of these groups.

A preferred refractory inorganic oxide for use as a binder is alumina. A suitable alumina material is a crystalline alumina known as a gamma-, an eta-, and a theta-alumina, with a gamma- or an eta-alumina being preferred.

The catalyst may contain a halogen component, including either fluorine, chlorine, bromine, iodine or a mixture thereof, with chlorine being preferred. Desirably, however, the catalyst contains no added halogen other than that associated with other catalyst components.

One shape for the support or catalyst can be an extrudate. Generally, the extrusion initially involves mixing of the zeolite with optionally the binder and a suitable peptizing agent to form a homogeneous dough or thick paste having the correct moisture content to allow for the formation of extrudates with acceptable integrity to withstand direct calcination. Extrudability may be determined from an analysis of the moisture content of the dough, with a moisture content in the range of about 30-about 70%, by weight, being preferred. The dough may then be extruded through a die pierced with multiple holes and the spaghetti-shaped extrudate can be cut to form particles in accordance with known techniques. A multitude of different extrudate shapes is possible, including a cylinder, a cloverleaf, a dumbbell, or a symmetrical or an asymmetrical polylobate. Furthermore, the dough or extrudate may be shaped to any desired form, such as a sphere, by, e.g., marumerization that can entail one or more moving plates or compressing the dough or extrudate into molds.

Alternatively, support or catalyst pellets can be formed into spherical particles by accretion methods. Such a method can entail adding liquid to a powder mixture of a zeolite and binder in a rotating pan or conical vessel having a rotating auger.

Generally, preparation of alumina-bound spheres involves dropping a mixture of molecular sieve, alsol, and gelling agent into an oil bath maintained at elevated temperatures. Examples of gelling agents that may be used in this process include hexamethylene tetraamine, urea, and mixtures thereof. The gelling agents can release ammonia at the elevated temperatures that sets or converts the hydrosol spheres into hydrogel spheres. The spheres may be then withdrawn from the oil bath and typically subjected to specific aging treatments in oil and an ammonia solution to further improve their physical characteristics. One exemplary oil dropping method is disclosed in U.S. Pat. No. 2,620,314.

Preferably, the resulting supports are then washed and dried at a relatively low temperature of about 50-about 200° C. and subjected to a calcination procedure at a temperature of about 450-about 700° C. for a period of about 1-about 20 hours.

Optionally, the catalyst is subjected to steaming to tailor its acid activity. The steaming may be effected at any stage of the zeolite treatment. Steaming conditions can include a water concentration of about 5-about 100%, by volume, pressure of about 100 kPa-about 2 MPa, and a temperature of about 600-about 1200° C. Preferably, the steaming temperature is about 650-about 1000° C., more preferably at least about 750° C., and optimally may be at least about 775° C. In some cases, temperatures of about 800-at least about 850° C. may be employed. The steaming should be carried out for a period of at least one hour, and periods of about 6-about 48 hours are preferred. Alternatively or in addition to the steaming, the composite may be washed with one or more solutions of an ammonium nitrate, a mineral acid, or water. The washing may be effected at any stage of the preparation, and two or more stages of washing may be employed. The catalyst can contain at least about 30%, preferably about 30-about 50%, by weight, silicon, based on catalyst.

The catalyst may be utilized to isomerize a feed stock including a non-equilibrium amount of at least one xylene and optionally ethylbenzene. The non-equilibrium alkylaromatic feed mixture can include isomerizable alkylaromatic hydrocarbons of the general formula:
C₆H(₆₋ₙ)Rₙ, where n is an integer of 1-5 and R is CH₃, C₂H₅, C₃H₇, or C₄H₉, in any combination suitable for isomerization to obtain at least one more valuable alkylaromatic isomer in an isomerized product. The feed mixture can include one or more ethylaromatic hydrocarbons containing at least one ethyl group, i.e., at least one R of at least one of the alkylaromatic hydrocarbons is C₂H₅. Suitable components of the feed mixture generally include, for example, an ethylbenzene, a meta-xylene, an ortho-xylene, a para-xylene, an ethyl-toluene, a trimethylbenzene, a diethyl-benzene, a triethylbenzene, a methylpropylbenzene, an ethylpropylbenzene, a diisopropylbenzene, or a mixture thereof. The one or more ethylaromatic hydrocarbons may be present in the feed mixture in a concentration of up to about 80%, by weight.

Isomerization of a non-equilibrium C8 aromatic feed mixture including xylenes and ethylbenzene is a particularly preferred application. Generally such a mixture may have an ethylbenzene content in the approximate range of about 0-about 50%, by weight, an ortho-xylene content in the approximate range of about 0-about 35%, by weight, a meta-xylene content in the approximate range of about 0-about 95%, by weight, and a para-xylene content in the approximate range of about 0-about 30%, by weight. Usually the non-equilibrium mixture is prepared by removal of para-, ortho- and/or meta-xylene from a fresh C8 aromatic mixture obtained from one or more aromatic-production or aromatic-conversion processes to yield a stream depleted in at least one xylene isomer.

The alkylaromatic feed mixture may be derived from any of a variety of original sources, e.g., petroleum refining, thermal or catalytic cracking of hydrocarbons, coking of coal, or petrochemical conversions in, e.g., a refinery or petrochemical production facility. Preferably, the feed mixture is found in appropriate fractions from various petroleum-refinery streams, e.g., as individual components or as certain boiling-range fractions obtained by the selective fractionation and distillation of catalytically cracked or reformed hydrocarbons. Such hydrocarbons can be sent to an aromatic production facility, such as disclosed in U.S. Pat. No. 6,740,788 B1, which may include a xylene isomer separation unit and a C8 isomerization unit. The isomerizable aromatic hydrocarbons need not be concentrated. Such alkylaromatic-containing streams, such as catalytic reformate with or without subsequent aromatic extraction, can be isomerized to produce specified xylene isomers and particularly to produce para-xylene. A C8 aromatic feed may contain nonaromatic hydrocarbons, i.e., naphthenes and paraffins, in an amount up to about 30%, by weight. Preferably the isomerizable hydrocarbons consist essentially of aromatics, however, to ensure pure products from downstream recovery processes. Typically, the non-equilibrium alkylaromatic feed mixture is an effluent from a xylene isomer separation unit.

Accordingly, an alkylaromatic hydrocarbon feed mixture may be contacted sequentially with two or more catalysts respectively in the C8 isomerization unit, discussed briefly above, having first and second isomerization zones. Typically, the first isomerization zone is at least for isomerizing at least one xylene and the second isomerization zone is at least for isomerizing ethylbenzene. Contacting may be effected in either zone using the catalyst system in a fixed-bed system, a moving-bed system, a fluidized-bed system, a slurry system or an ebullated-bed system, or a batch-type operation. Preferably, a fixed-bed system is utilized in both zones.

In a preferred manner, the feed mixture is preheated by suitable heating means as known in the art to the desired reaction temperature and passes in a liquid phase in the substantial absence of hydrogen into the first isomerization zone containing a fixed bed or beds of the first isomerization catalyst. The first isomerization zone may include a single reactor or two or more separate reactors with suitable measures to ensure that the desired isomerization temperature is maintained at the entrance to each reactor. The reactants may be contacted with the catalyst bed in upward-, downward-, or radial-flow fashion to obtain an intermediate stream that may contain alkylaromatic isomers in a ratio differing from the feed mixture. In the preferred processing of one or more C8 aromatics, the intermediate stream can contain xylenes in proportions closer to equilibrium than in the feed mixture plus ethylbenzene in a proportion relating to the feed mixture.

The alkylaromatic feed mixture, preferably a non-equilibrium mixture of one or more C8 aromatics, may contact the isomerization catalyst in the liquid phase at suitable first isomerization conditions. Such conditions can include a temperature ranging from about 200-about 1000° C., and preferably from about 200-about 400° C. Generally, the pressure is sufficient to maintain the feed mixture in liquid phase, generally from about 500 kPa-about 5 MPa. The first isomerization zone can contain a sufficient volume of catalyst to provide a liquid hourly space velocity with respect to the feed mixture of about 0.5-about 50 hr⁻¹, preferably about 0.5-about 20 hr⁻¹.

At least part of the intermediate stream, and preferably the entire intermediate stream without a further processing step, may be contacted in a second isomerization zone with a second isomerization catalyst. Desirably, without passing through a separation device, the intermediate stream can be preheated by suitable exchanger and/or heater in the presence of a hydrogen-rich gas to the desired reaction temperature and then passed into the second isomerization zone containing one or more fixed beds of a second isomerization catalyst. Exemplary conditions and catalyst for the second isomerization zone are disclosed in US 2007/0004947 A1.

The isomerized product from the second isomerization zone can include a concentration of at least one alkylaromatic isomer that is higher than the equilibrium concentration at the second isomerization condition. Desirably, the isomerized product is a mixture of one or more C8 aromatics having a concentration of para-xylene that is higher than the equilibrium concentration at the second isomerization conditions. The concentration of para-xylene can be at least about 24.2%, often at least about 24.4%, and may be at least about 25%, by weight. The C8 aromatic ring loss relative to the feed mixture (defined hereinafter) is usually less than about 2.0% and preferably less than about 1.5%.

Any effective recovery mechanism known in the art may be used to recover a particular isomer from the isomerized product. Typically, a reactor effluent is condensed and the hydrogen and light-hydrocarbon components are removed therefrom by flash separation. The condensed liquid product then is fractionated to remove light and/or heavy byproducts to obtain the isomerized product. In some instances, certain product species, such as ortho-xylene, may be recovered from the isomerized product by selective fractionation. The isomerized product from isomerization of the one or more C8 aromatics usually is processed to selectively recover the para-xylene isomer, optionally by crystallization. Selective adsorption is preferred using crystalline aluminosilicates according to U.S. Pat. No. 3,201,491. Another exemplary adsorption recovery process is described in U.S. Pat. No. 4,184,943.

The elemental analysis of the catalyst components can be determined by Inductively Coupled Plasma (ICP) analysis. Some components, such as metals, can be measured by UOP Method 873-86 and other components, such as the zeolite or binder where each may contain silica, or silicon can be measured by UOP Method 961-98.

All the UOP methods, such as UOP-873-86 and UOP-961-98 discussed herein, can be obtained through ASTM International, 100 Barr Harbor Drive, West Conshohocken, Pa., USA.

### Illustrative Embodiments

The following examples are intended to further illustrate the subject catalyst. These illustrations of embodiments of the invention are not meant to limit the claims of this invention to the particular details of these examples. These examples are based on engineering calculations and actual operating experience with similar processes.

### Example 1

A gallium-aluminum substituted zeolite catalyst is prepared by preparing a first solution of 13.2 grams of Ga₂O₃, 2.7 grams of Al(OH)₃, and 39.9 grams of NaOH with 63 grams of water. A second solution is prepared by combining 842 grams of a silica source, such as a silica source sold under the trade designation of LUDOX AS40 by E. I. Du Pont De

Nemours and Company corporation of Wilmington, Del., with 100 grams of water and mixing. During mixing of the second solution, 138 grams of an organic template, such as tetrapropylammonium bromide, is added, and then the first solution is added to the second solution. The mixing of the combined solutions is continued until the mixture thickens and then thins to a gel. Afterwards, the gel is transferred to an autoclave and reacted for about 72 hours at a temperature of about 120-about 131° C. The solid material is separated using a centrifuge and washed three times with water. Subsequently, the solid material is dried and determined by x-ray diffraction to be a zeolite with an MFI structure.

The zeolite obtained from the autoclave is calcined in nitrogen for 2 hours and air for 10 hours at a temperature of about 560° C. After calcination, the zeolite is ammonium cation exchanged with 1.5 M NH₄NO₃ solution at about 75° C. The obtained zeolite is filtered, and ammonium cation exchanged again with the 1.5 M NH₄NO₃ solution at about 75° C. Afterwards, the zeolite is dried at 100° C. for about 12 hours to yield a gallium-aluminum substituted pentasil zeolite catalyst containing about 3.0%, by weight, gallium and about 0.2%, by weight, aluminum based on the zeolite or catalyst, with a mole ratio of silicon to gallium of about 35:1 and of silicon to aluminum of about 175:1, based on the zeolite or catalyst. The catalyst can include about 100%, by weight, zeolite, and no binder.

### Example 2

A gallium-aluminum substituted zeolite catalyst is prepared similarly to Example 1, except with sufficient amounts of Ga₂O₃ and Al(OH)₃ to yield a catalyst containing about 3.0%, by weight, gallium, and about 0.6%, by weight, aluminum, based on the catalyst.

### Example 3

A gallium-aluminum substituted zeolite catalyst is prepared similarly to Example 1, except with sufficient amounts of Ga₂O₃ and Al(OH)₃ to yield a catalyst containing about 3.0%, by weight, gallium, and about 1.0%, by weight, aluminum, based on the catalyst.

### Example 4

A gallium-aluminum substituted zeolite catalyst is prepared similarly to Example 1, except with sufficient amounts of Ga₂O₃ and Al(OH)₃ to yield a catalyst containing about 4.0%, by weight, gallium, and about 0.2%, by weight, aluminum, based on the catalyst.

### Example 5

A gallium-aluminum substituted zeolite catalyst is prepared similarly to Example 1, except with sufficient amounts of Ga₂O₃ and Al(OH)₃ to yield a catalyst containing about 4.0%, by weight, gallium, and about 1.0%, by weight, aluminum, based on the catalyst.

### Comparison Example 1

A gallium-aluminum substituted zeolite catalyst is prepared similarly to Example 1, except with sufficient amounts of Ga₂O₃ to yield a catalyst containing about 3.0%, by weight, gallium. No aluminum is added to the catalyst.

### Comparison Example 2

A gallium-aluminum substituted zeolite catalyst is prepared similarly to Example 1, except with sufficient amounts of Ga₂O₃ to yield a catalyst containing about 4.0%, by weight, gallium. No aluminum is added to the catalyst.

### Performance

The catalysts discussed above are placed in a pilot plant flow reactor. The reactor processes a non-equilibrium C8 aromatic feed having the following approximate composition:

TABLE 1
Feed Composition

| Component | Weight % |
|---|---|
| Ethylbenzene | 14 |
| Para-xylene | <1 |
| Meta-xylene | 55 |
| Ortho-xylene | 22 |
| Toluene | 1 |
| C8 paraffins | <1 |
| C8 naphthenes | 6 |
| Water | 0.01-0.02 |

This feed in a liquid phase is contacted with each catalyst depicted below in Table 2 at a pressure of about 3500 kPa and a temperature of about 300° C. with no hydrogen.

The C8 ring loss or C8RL is in mole percent and defined as: (1-(C8 naphthenes and aromatics in product)/(C8 naphthenes and aromatics in feed))*100 which represents a loss of one or more C8 rings that can be converted into a desired C8 aromatic, such as para-xylene. This loss of feed generally requires more feed to be provided to generate a given amount of product, reducing the profitability of the unit. Generally, a low amount of C8RL is a favorable feature for a catalyst. The C8RL can be measured in the table below at a conversion of the following formula:

pX/X=[pX/(pX+mX+oX)]*100%

where:
pX represents moles of para-xylene in the product;
mX represents moles of meta-xylene in the product;
oX represents moles of ortho-xylene in the product; and
X represents moles of xylene in the product.

Thus, the C8RL and a weight hourly space velocity (may be referred to as WHSV) in the table below are determined at pX/X of 23% in a product stream.

TABLE 2

| | | |
|---|---|---|
| | 3.0% Gallium | 4.0% Gallium |
| Aluminum | (Weight %) | (Weight %) |

| (Weight %) | WHSV | C8RL | WHSV | C8RL |
|---|---|---|---|---|
| 0 | 10 | 0.6 | 18 | 0.8 |
| 0.2 | 20 | 0.7 | 28 | 0.9 |
| 0.6 | 36 | 0.9 | — | — |
| 1.0 | 38 | 1.4 | 42 | 1.0 |

As depicted above, catalysts having aluminum of 0.2-1.0%, particularly 0.2-0.6%, by weight, have a C8RL comparable to catalysts with no aluminum. Generally, catalysts prepared by methods as discussed above can have enhanced isomerization activity while minimizing C8RL.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. An aromatic production facility, comprising:
A) a xylene isomer separation unit; and
B) a C8 aromatic isomerization unit receiving a stream depleted in at least one xylene isomer from the xylene isomer separation unit; wherein the C8 aromatic isomerization unit comprises at least one zone at least for isomerizing at least one xylene, the zone comprising catalyst, in turn, comprising:
1) a molecular sieve wherein the molecular sieve comprises:
a) at least about 40%, by weight, silicon;
b) about 0.5-about 7.0%, by weight, gallium; and
c) about 0.1-about 2.0%, by weight, of another IUPAC Group 13 element wherein the silicon, gallium and the another IUPAC Group 13 element are calculated on an elemental basis;
d) wherein the molecular sieve comprises at least one of an MFI, MEL, FER, MOR, TON, MTW, EUO, and MTT zeolite; and
2) a binder.

2. The aromatic production facility according to claim 1, wherein the C8 aromatic isomerization unit comprises:
the first zone at least for isomerizing at least one xylene; and
a second zone at least for isomerizing ethylbenzene.
